(19) United States
(12) Patent Application Publication
(10) Pub. No.: US 2023/0198259 A1
(43) Pub. Date: Jun. 22, 2023

(54) DEVICE AND METHOD FOR STABILIZING AN AC VOLTAGE GRID

(71) Applicant: SIEMENS AKTIENGESELLSCHAFT, München (DE)

(72) Inventor: Martin Pieschel, Altdorf (DE)

(21) Appl. No.: 17/926,230

(22) PCT Filed: May 20, 2020
(86) PCT No.: PCT/EP2020/064125

§ 371 Date: Nov. 18, 2022

(51) Int. Cl. H02J 3/24; H02J 3/28; H02M 7/219

(52) U.S. Cl. CPC H02J 3/24; H02J 3/28; H02M 7/219; H02J 2207/20

(57) ABSTRACT

A device for stabilizing an AC voltage grid includes a power converter having an AC voltage side for connection to the AC voltage grid and a DC voltage side having two DC voltage poles. An energy storage arrangement is connected on the DC voltage side of the converter between the DC voltage poles. A controlled load for absorbing active power or consuming active power is disposed in series or parallel with the energy storage arrangement. A method is also provided for stabilizing an AC voltage grid by using the device.

The invention relates to a device for stabilizing an AC voltage grid comprising a power converter with an AC voltage side for connection to the AC voltage grid and a DC voltage side with two DC voltage poles, and comprising an energy storage arrangement that is connected between the DC voltage poles on the DC voltage side of the power converter.

The stabilizing effect of the device is in particular based on the fact that the device is configured to exchange active and reactive power with the AC voltage grid. Controllable buffer-storage of the energy is becoming increasingly important in particular in connection with generators of energy from renewable sources.

The energy storage arrangement usually comprises short-term energy stores (generally capacitive energy stores). The device can therefore be used for rapid frequency support, for example when shedding powerful loads or generators. The grid frequency can be kept within a range predefined by the grid operator by means of the device. If the grid frequency leaves the permissible range, there is the danger of a chain reaction through deactivation of other feed-in inverters (such as the inverters of photovoltaic installations). This can ultimately result in a grid failure.

A device of the generic type is disclosed in WO 2020/007464 A1. The known device comprises a power converter that is a modular multilevel converter in a double-star configuration. Parallel-connected energy storage branches comprising voltage converter modules and energy storage modules are arranged between DC-voltage-side poles of the power converter.

The object of the invention is to specify a device of the generic type that is as effective and reliable as possible during operation.

In a device of the generic type, the object is achieved according to the invention by means of a controlled load, for absorbing active power or consuming active power, that is arranged in series or in parallel with the energy storage arrangement. By way of example, the load comprises a consumption unit, through which current can flow in a controlled manner. The load can for example take up power and convert this into heat.

An important advantage of the device according to the invention is that the device according to the invention can take up active power from the grid for longer in comparison to the known devices without the energy content of the energy storage arrangement having to be necessarily increased. Using the device according to the invention, in particular the disadvantage of having to equip the energy storage arrangement with more energy storage units in order to increase a take-up capacity of said energy storage arrangement can therefore be avoided. This in turn, by virtue of the device according to the invention, allows the disadvantage of an increased space requirement to be avoided. It is additionally possible in this way to improve the availability of the device, since the failure rate of the components increases in line with the number thereof. The load can both take up the active power instead of the energy storage arrangement and delay charging of the energy storage arrangement by way of an appropriate partial take-up of active power. In addition, the load can be used to discharge the energy storage arrangement relatively quickly when the power converter is shutting down.

The load preferably comprises at least one resistor element, for example a passive resistor element, e.g. a dry resistor or a high-power resistor known to a person skilled in the art. This constitutes a cost-effective and simple, and therefore particularly reliable, variant for the load. The resistor element is connected to the energy storage arrangement as a separate component. Power can be converted into heat by means of the resistor element. By way of example, the waste heat arising in this case can be output to ambient air or to a cooling water circuit, for example a cooling water circuit of the power converter. The load can comprise a plurality of resistor elements that are connected to one another in any desired circuit topologies, in particular a series and/or parallel circuit.

According to one embodiment of the invention, the load is connected in series with the energy storage arrangement, wherein at least one diode is connected in parallel with the resistor element (or, for example, a series circuit of resistor elements). The forward direction of the diode is selected in such a way that it is ensured that the load is not effective (i.e. no current flows through the resistor element) when the active power is being output by the device. The current through the load (and therefore the load itself) is controlled using the diode. Arranging the load in series with the energy storage arrangement has the particular advantage that the load in this case can have a lower insulation capability than a load connected in parallel with the energy storage arrangement.

If the load is connected in series with the energy storage arrangement, the resistance value R of the load can therefore expediently be dimensioned such that the maximum power converter DC voltage Udc, the maximum voltage Usp of the energy storage arrangement and the active power P to be taken up are taken into account: R=(Udc−Usp)*Udc/P.

The load is preferably connected in series with the energy storage arrangement, wherein a bypass switch is connected in parallel with the resistor element, by means of which bypass switch the at least one resistor element (or an interconnection of resistor elements) can be bypassed. By means of suitable control of the bypass switch, the load or the resistor element can be connected in or bypassed in order to accordingly exert the effect thereof.

According to one embodiment of the invention, the load comprises a braking controller, that is to say a controllable apparatus for converting electrical energy into heat.

The braking controller preferably has a series circuit of braking controller modules. By way of example, a braking controller module comprises a braking controller power module with passive or controllable, preferably activatable, semiconductor switches and with a DC voltage intermediate circuit, to which a braking controller capacitor module comprising a capacitor is connected. This variant of the braking controller is particularly flexible and effective, since in each case a number of braking controller modules that is adapted to the specific application can be switched to be active or inactive at a given time. The braking controller modules can be suitably actuated such that the energy storage arrangement is charged with a constant current. To this end, the power converter can output its maximum DC voltage.

According to one embodiment of the invention, the load forms a series circuit with a switching unit that is connected in parallel with the energy storage arrangement. The switching unit can be used to activate or deactivate the load, and so the latter is controllable.

According to one embodiment of the invention, the load comprises a first load branch and a second load branch that are arranged in parallel with one another, wherein the first load branch comprises at least one controllable resistor element and the second load branch comprises a further controllable resistor element or a braking controller. According to this embodiment variant, the load can be used particularly effectively. The load branch comprising the resistor elements can be used to absorb large powers. The load branch comprising the braking controller can take up smaller amounts of active power that occur.

The resistor element can expediently be controlled by means of a semiconductor switch or a mechanical switch in series with the resistor element (or, if a circuit of a plurality of resistor elements is provided, in parallel with this circuit). The semiconductor switch can be, for example, an activatable semiconductor switch (for example an IGBT, IGCT, IEGT, MOSFET or the like). A freewheeling diode can be connected in antiparallel with the semiconductor switch.

The energy storage arrangement suitably comprises a plurality of parallel-connected series circuits comprising energy storage units. In this way, the device is scalable in terms of its energy storage arrangement take-up capacity. Low-voltage storage units can also be used in the energy storage arrangement.

The power converter is preferably a modular multilevel power converter (MMC) in a double-star arrangement. In particular, the MMC has advantages relating to the effectiveness and reliability of the exchange of active and reactive power with the AC voltage grid. The MMC is distinguished by power converter arms that each have a series circuit of switching modules. Each switching module in this case comprises deactivatable semiconductor switches and a module energy store. By means of suitable actuation of the semiconductor switches, at least one switching module voltage can be produced at connections of the switching module that corresponds to an energy storage voltage of positive, in the case of bipolar switching modules also negative, polarity or a zero voltage.

The invention also relates to a method for operating a device for stabilizing an AC voltage grid, comprising a power converter with an AC voltage side for connection to the AC voltage grid and a DC voltage side with two DC voltage poles, and an energy storage arrangement that is connected between the DC voltage poles on the DC voltage side of the power converter.

A method of this kind is disclosed in WO 2020/007464 A1, which has already been mentioned.

The object of the invention is to specify a method of this type that allows stabilization of the AC voltage grid that is as effective and cost-effective as possible.

The object is achieved, in a method of the generic type, in that a controlled load for absorbing active power or consuming active power is provided and is arranged in series or parallel with the energy storage arrangement, active power is taken up from the AC voltage grid and is stored by means of the energy storage arrangement, wherein the take-up of active power is delayed or slowed down by means of the controlled load. By means of the method according to the invention, the device can take up active power from the grid for longer, without an expensive increase in a take-up capacity of the energy storage arrangement. Improved effectiveness for the grid stabilization can therefore be achieved. Further advantages emerge from those that have already been discussed in connection with the device according to the invention.

According to one embodiment variant of the invention, if the taken-up active power has reached a take-up capacity threshold, further active power is drawn from the AC voltage grid and is at least partially converted into heat by means of the controlled load. Active power can therefore still be absorbed from the grid even beyond the take-up capacity threshold of the energy storage arrangement.

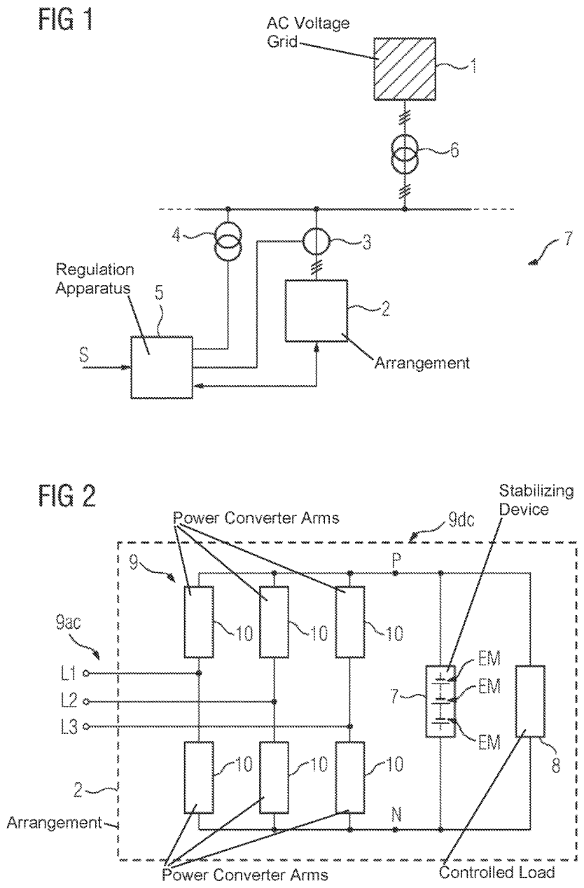

The invention is explained in more detail below on the basis of FIGS. 1 to 25.

FIG. 1 shows a schematic illustration of a first exemplary embodiment of a device according to the invention;

FIG. 2 shows a schematic illustration of a section of the device in FIG. 1;

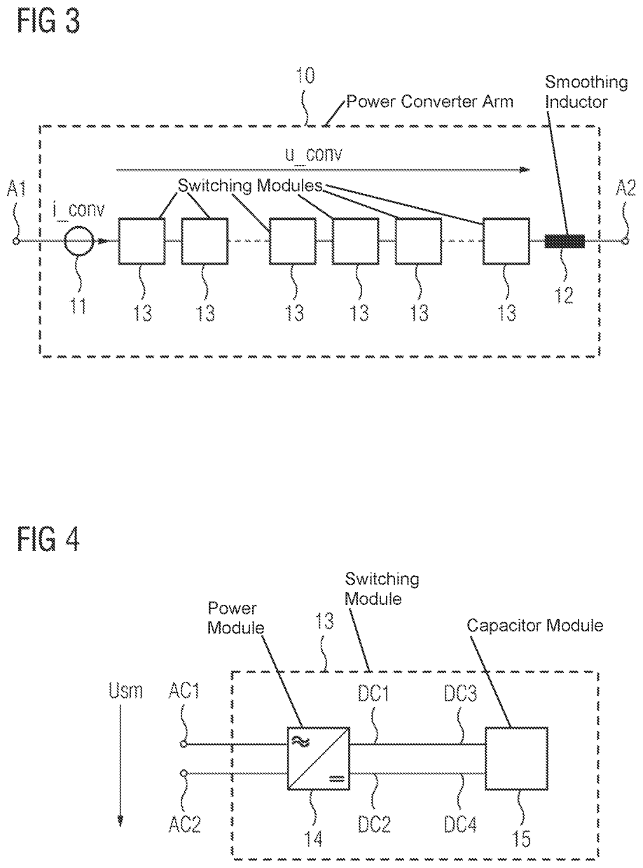

FIG. 3 shows a schematic illustration of an example of a power converter arm for a power converter of the device in FIGS. 1 and 2;

FIG. 4 shows a schematic illustration of a switching module for the power converter of the device in FIGS. 1 and 2;

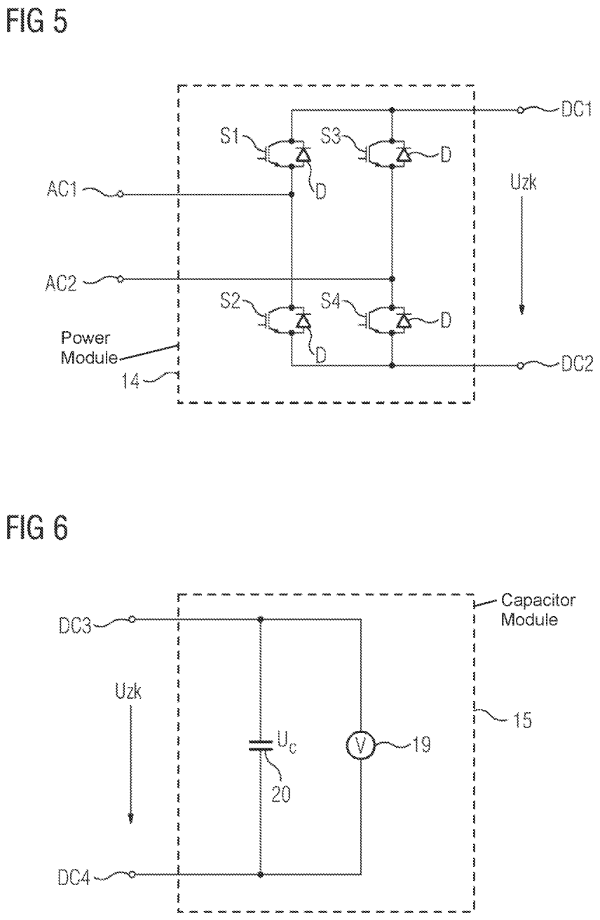

FIG. 5 shows a schematic illustration of a first section of the switching module in FIG. 4;

FIG. 6 shows a schematic illustration of a second section of the switching module in FIG. 5;

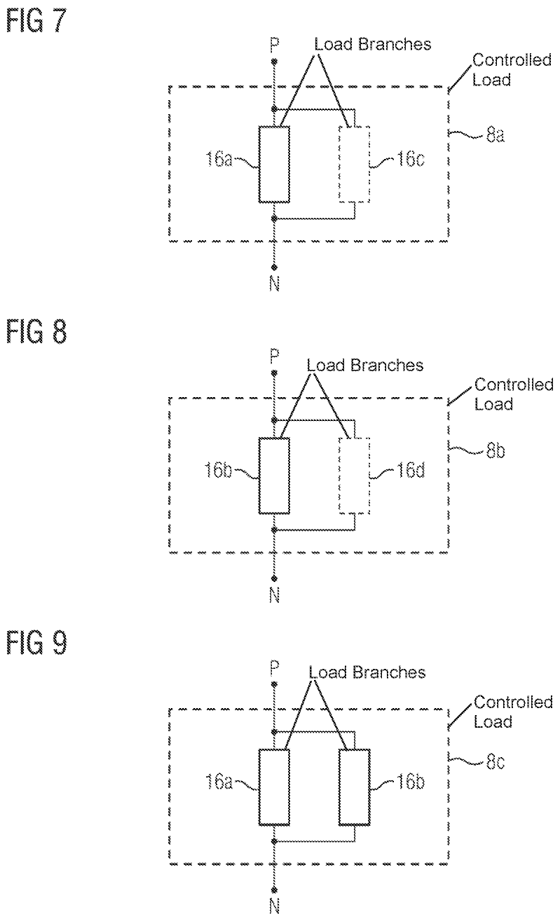

FIG. 7 shows a schematic illustration of a first example of a load for the device in FIG. 1;

FIG. 8 shows a schematic illustration of a second example of a load for the device in FIG. 1;

FIG. 9 shows a schematic illustration of a third example of a load for the device in FIG. 1;

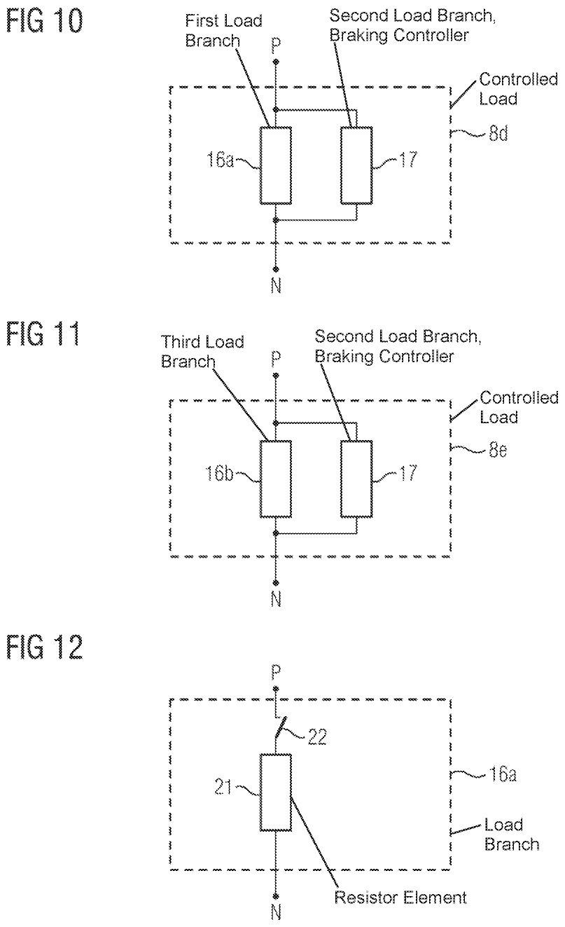

FIG. 10 shows a schematic illustration of a fourth example of a load for the device in FIG. 1;

FIG. 11 shows a schematic illustration of a fifth example of a load for the device in FIG. 1;

FIG. 12 shows a schematic illustration of a first section of the load in FIGS. 7 to 11;

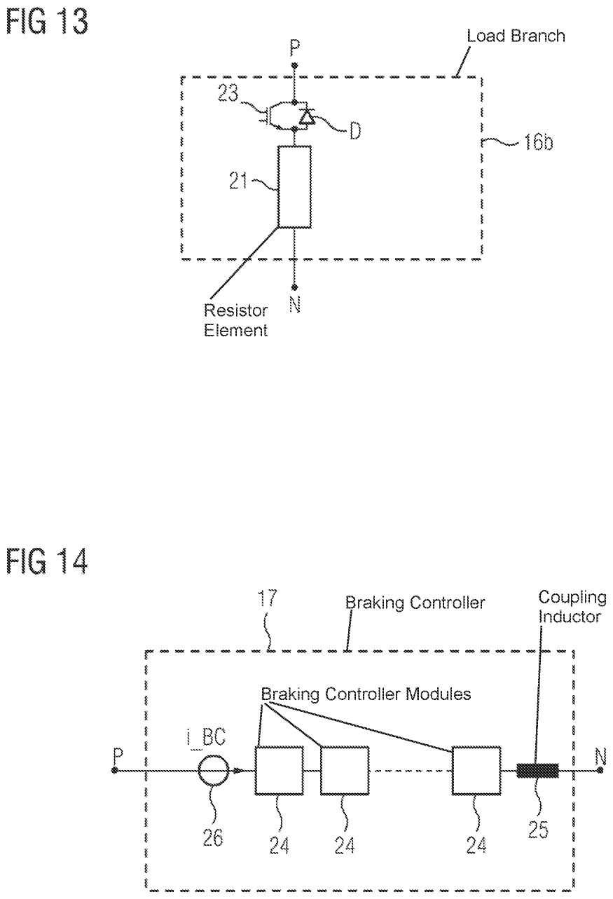

FIG. 13 shows a schematic illustration of a second section of the load in FIGS. 7 to 11;

FIG. 14 shows a schematic illustration of an example of a braking controller;

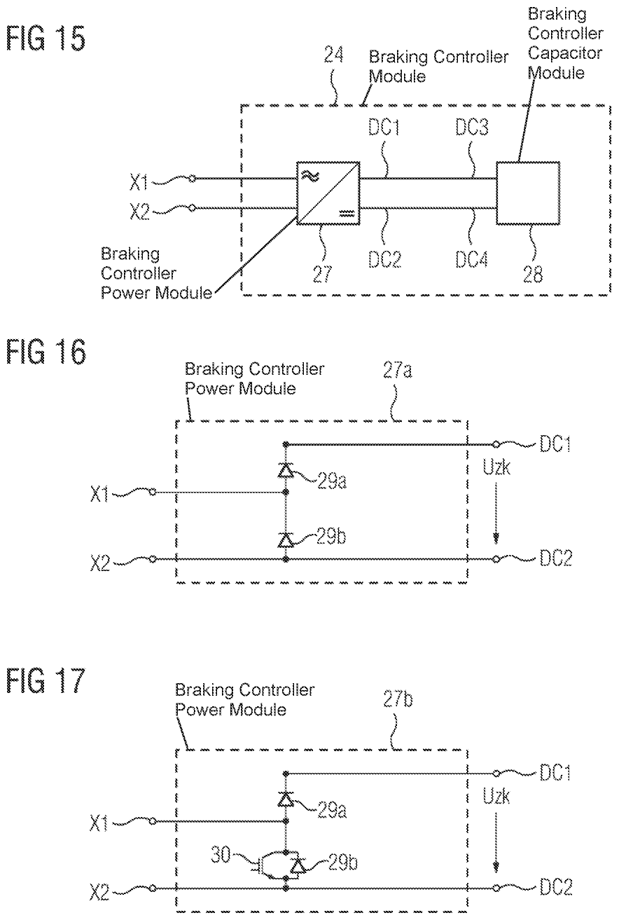

FIG. 15 shows a schematic illustration of a braking controller module for the braking controller in FIG. 14;

FIG. 16 shows a schematic illustration of a first example of a braking controller power module;

FIG. 17 shows a schematic illustration of a second example of a braking controller power module;

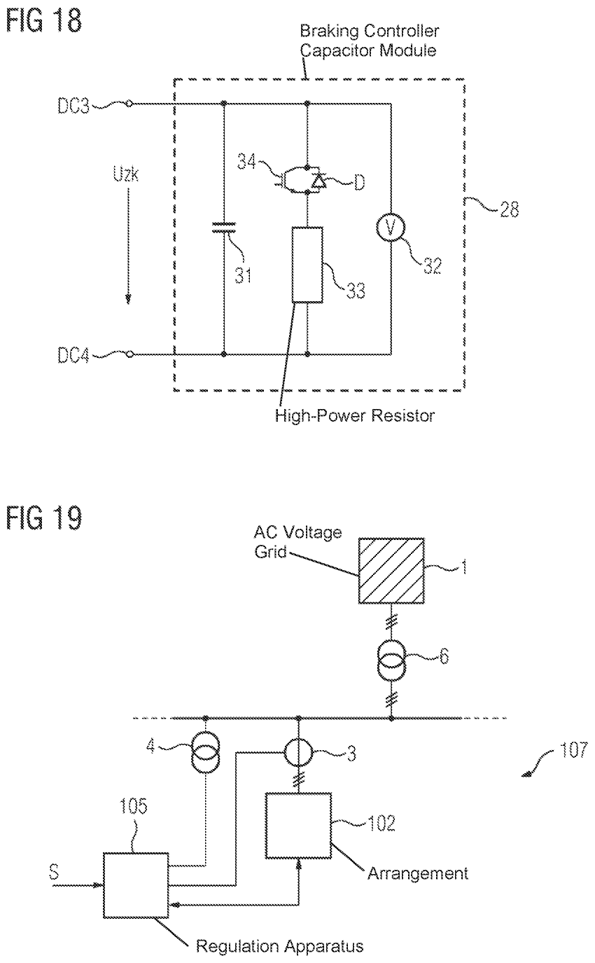

FIG. 18 shows a schematic illustration of a braking controller capacitor module;

FIG. 19 shows a schematic illustration of a second exemplary embodiment of a device according to the invention;

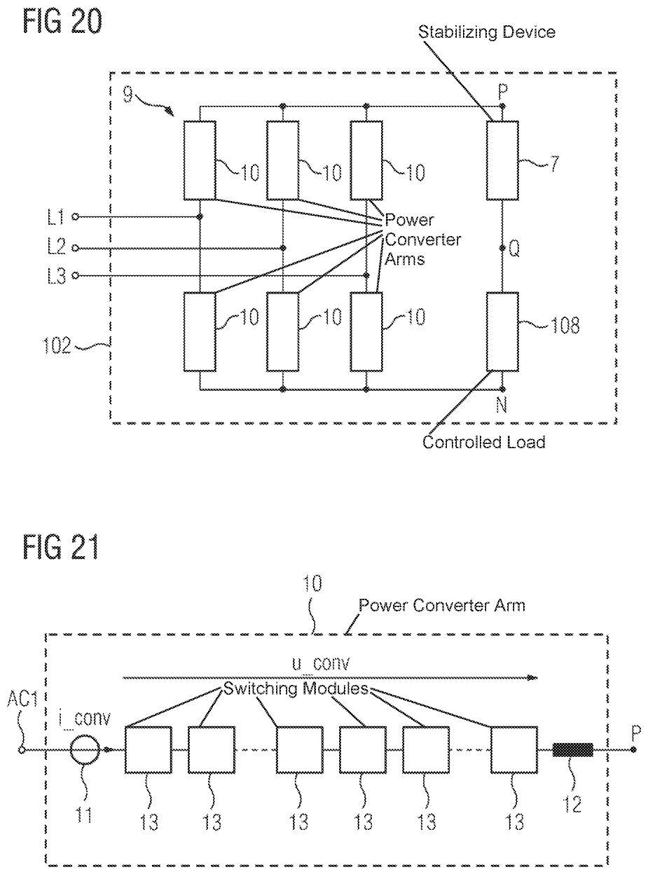

FIG. 20 shows a schematic illustration of a section of the device in FIG. 19;

FIG. 21 shows a schematic illustration of an example of a power converter arm for a power converter of the device in FIG. 19;

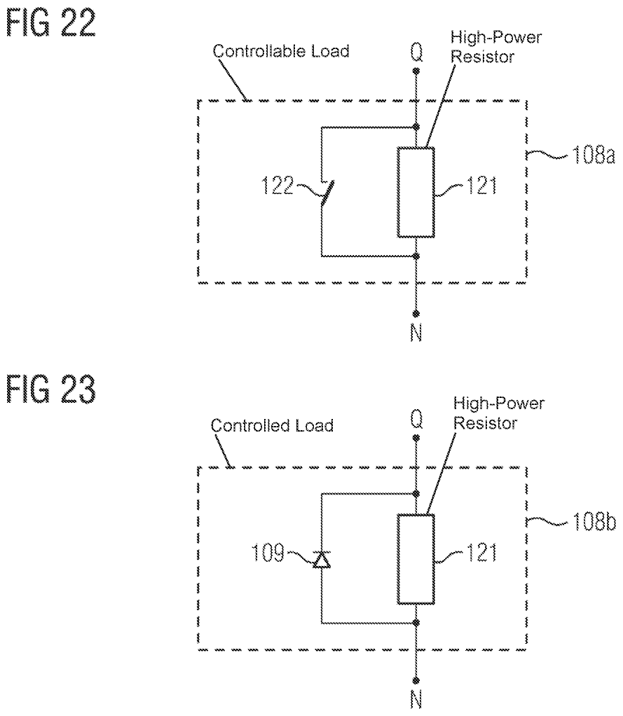

FIG. 22 shows a schematic illustration of a first example of a load for the device in FIG. 19;

FIG. 23 shows a schematic illustration of a second example of a load for the device in FIG. 19;

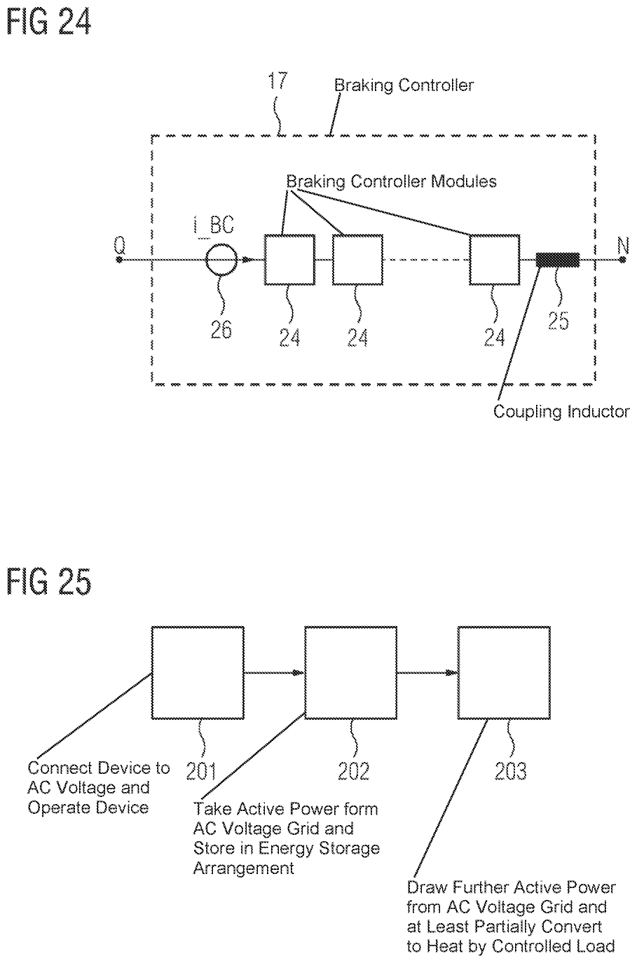

FIG. 24 shows a schematic illustration of a braking controller for the device in FIG. 19;

FIG. 25 shows a flowchart of a method according to the invention.

FIG. 1 shows a device 7 for stabilizing an AC voltage grid 1. The device 7 comprises an arrangement 2 comprising a power converter and an energy storage installation that is connected to the AC voltage grid 1 by means of a connecting transformer 6. The structure of the arrangement 2 will be looked at in more detail in the following FIG. 2. The device 7 also comprises a central regulation or control apparatus 5. The regulation apparatus 5 receives a set S of predefined setpoint values and measured values from a voltage measuring device 4 and a current measuring device 3. The regulation apparatus 5 is configured to regulate an exchange of active and reactive power between the arrangement 2 and the AC voltage grid, taking into account the measured and setpoint values. For reasons of clarity, identical and similar elements in all the figures are provided with the same reference symbols.

FIG. 2 shows a section of the device 7 in FIG. 1 comprising the arrangement 2. FIG. 2 shows a power converter 9 that is a modular multilevel converter (MMC) in a double-star configuration. The power converter 9 comprises six power converter arms 10. Three of the power converter arms 10 are connected to one another in a first star connection with a first star point or DC voltage pole P. A further three of the power converter arms 10 are connected to one another in a second star point connection with a second star point or DC voltage pole N. Each of the power converter arms extend between one of three AC voltage connections L1-L3 and one of the two DC voltage poles P,N. The structure of the power converter arms 10 will be looked at in more detail in the following FIG. 3. The AC voltage connections L1-L3 form an AC voltage side 9ac of the power converter 9 for connection to the AC voltage grid 1. The DC voltage poles P,N form a DC voltage side 9dc of the power converter 9 for connection to an energy storage arrangement E. The energy storage arrangement E comprises one or more series circuits of energy storage modules EM that can be arranged in parallel with one another. The energy storage modules EM can have, for example, ultracapacitors or comparable short-term energy stores.

A controlled load 8 is arranged in parallel with the energy storage arrangement E and between the DC voltage poles P,N of the power converter 9, by means of which load additional active power can be taken up from the AC voltage grid 1 and possibly converted into heat. For this purpose, it is possible for current to flow through the load in a controlled manner. The structure of the load 8 will be looked at in more detail below in connection with FIGS. 7 to 18.

FIG. 3 shows an example of a power converter arm 10 for the power converter 9 in FIG. 2. The power converter arm 10 has two connections A1 and A2, by means of which the power converter arm can be connected between one of the AC voltage connections L1-3 and one of the DC voltage poles P or N. The power converter arm 10 comprises a series circuit of switching modules 13, the structure of which will be looked at in more detail in the following FIGS. 4 to 6. The switching module voltages dropped across the switching modules 13 add up to form an arm voltage u_conv. The power converter arm also comprises a smoothing inductor 12. An arm current i_conv through the power converter arm 10 is detected by means of an ammeter 11 and is forwarded to the regulation apparatus of the power converter.

FIG. 4 shows a switching module 13 for the power converter arm 10 in FIG. 3. The switching module 13 has a first connection AC1 and a second connection AC2 at which a switching module voltage Usm is present. The switching module 13 comprises a power module 14 and a capacitor module 15 that are connected to one another via suitable connections or terminals DC1-4. The structure of the power module 14 and of the capacitor module 15 will be looked at in more detail in the following FIGS. 5 and 6.

FIG. 5 shows a power module 14 for a switching module 13 in FIG. 4. In the example shown in FIG. 5, this is a full-bridge power module for a full-bridge switching module. The power module 14 comprises four semiconductor switches (IGBTs in the example shown), a freewheeling diode D being connected in antiparallel with each of them. The two terminals DC1, DC2 at the DC voltage intermediate circuit serve for connection to the capacitor module 15. An intermediate circuit voltage Uzk is present at the DC voltage intermediate circuit.

FIG. 6 shows a capacitor module 15 for a switching module 13 in FIG. 4. The capacitor module has two terminals DC3 and DC4 for connection to the power module 14. An energy store 20 in the form of a capacitor is arranged in parallel with the terminals DC3, DC4. A voltage Uc present at the energy store is monitored by means of a voltmeter 19.

FIG. 7 shows an example of a controlled load 8a that can be used as the load 8 of the device 7 in FIG. 1. The load 8a comprises two parallel load branches 16a and 16c, wherein the structure of the load branches 16a and 16c will be looked at in more detail in the following FIG. 12.

FIG. 8 shows an example of a controlled load 8b that can be used as the load 8 of the device 7 in FIG. 1. The load 8b comprises two parallel load branches 16b and 16d, wherein the structure of the load branches 16b and 16d will be looked at in more detail in the following FIG. 13.

FIG. 9 shows an example of a controlled load 8c that can be used as the load 8 of the device 7 in FIG. 1. The load 8c comprises two parallel load branches 16a and 16b, wherein the structure of the first load branch 16a will be looked at in more detail in FIG. 12 and the structure of the second load branch 16b will be looked at in more detail in the following FIG. 13.

FIG. 10 shows an example of a controlled load 8d that can be used as the load 8 of the device 7 in FIG. 1. The load 8d comprises two parallel load branches, a first load branch 16a and a second load branch with a braking controller 17, wherein the structure of the load branch 16a will be looked at in more detail in the following FIG. 12 and the structure of the braking controller 17 will be looked at in more detail in the following FIGS. 14 to 18.

FIG. 11 shows an example of a controlled load 8e that can be used as the load 8 of the device 7 in FIG. 1. The load 8e comprises two parallel load branches, a third load branch 16b and the second load branch with a braking controller 17, wherein the structure of the load branch 16b will be looked at in more detail in the following FIG. 13 and the structure of the braking controller 17 will be looked at in more detail in the following FIGS. 14 to 18.

FIG. 12 shows a load branch 16a that, for example, can be used as the load branch 16a and also the load branch 16c in FIGS. 7, 9 and 10. The load branch 16a is arranged between the first and the second DC voltage pole P or N of the power converter 9. The load branch 16a comprises a resistor element 21 and a mechanical switch 22 in series with the resistor element 21.

FIG. 13 shows a load branch 16b that, for example, can be used as the load branch 16b and also the load branch 16d in FIGS. 8, 9 and 11. The load branch 16b is arranged between the first and the second DC voltage pole P or N of the power converter 9. The load branch 16b comprises a resistor element 21. The load branch 16b also comprises a parallel circuit 23 of a deactivatable semiconductor switch S (an IGBT in the example shown) and an antiparallel freewheeling diode D (the forward directions of the semiconductor switch and the freewheeling diode are opposite to one another).

FIG. 14 shows a braking controller 17 for the loads 8d, 8e in FIGS. 10 and 11. The braking controller 17 comprises a coupling inductor 25 and a series circuit of a plurality of braking controller modules 24 that have an identical structure in the example shown. A current i_BC through the braking controller 17 is measured by means of an ammeter 26 and used to regulate the braking controller 17 by means of a regulator that is not shown in greater detail. The structure of the braking controller modules 24 will be looked at in more detail in the following FIGS. 15 to 18.

FIG. 15 shows a braking controller module 24 for the braking controller in FIG. 14. The braking controller module 24 has two connections X1 and X2 for inserting the braking controller module 24 into the corresponding series circuit as shown in FIG. 14. The braking controller module 24 also comprises a braking controller power module 27, the structure of which will be looked at in detail in connection with FIGS. 16 and 17, and a braking controller capacitor module 28 that is shown in detail in FIG. 18. The braking controller power module 27 and the braking controller capacitor module 28 are connected to one another by means of connecting terminals or ports DC1-4 configured for this purpose.

FIG. 16 shows a first example of a braking controller power module 27a that can be used as the braking controller power module 27 of the braking controller module 17 in FIG. 15. The braking controller power module 27a comprises a first diode 29a and a second diode 29b, which have the same forward direction and are arranged in series between the connecting terminals DC1 and DC2. The first connection X1 of the braking controller module 24 is arranged between the diodes 29, and the second connection X2 of the braking controller module 24 is arranged between the diode 29b and the second connecting terminal DC2.

FIG. 17 shows a second example of a braking controller power module 27b that can be used as the braking controller power module 27 of the braking controller module 17 in FIG. 15. The braking controller power module 27b comprises a first diode 29a and a second diode 29b, which have the same forward directions and are arranged in series between the connecting terminals DC1 and DC2. The first connection X1 of the braking controller module 24 is arranged between the diodes 29, and the second connection X2 of the braking controller module 24 is arranged between the diode 29b and the second connecting terminal DC2. The braking controller power module 27b also comprises a deactivatable semiconductor switch 30 (e.g. IGBT) that is connected in antiparallel with the second diode 29b.

FIG. 18 shows an example of a braking controller capacitor module 28 for the braking controller module 24 in FIG. 15. The braking controller capacitor module 28 comprises an energy store 31 in the form of a capacitor that is arranged in parallel with the connecting terminals DC3 and DC4. A series circuit comprising a high-power resistor 33 and a semiconductor switch 34 comprising an antiparallel freewheeling diode D is connected in parallel with the energy store 31. A parallel-connected energy store voltmeter 32 is additionally provided. Voltage present at the energy store is denoted by Uzk.

FIG. 19 shows a device 107 for stabilizing an AC voltage grid 1. The device 107 comprises an arrangement 102 comprising a power converter and an energy storage installation that is connected to the AC voltage grid 1 by means of a connecting transformer 6. The structure of the arrangement 102 will be looked at in more detail in the following FIG. 20. The device 107 also comprises a central regulation or control apparatus 105. The regulation apparatus 105 receives a set S of predefined setpoint values and measured values from a voltage measuring device 4 and a current measuring device 3. The regulation apparatus 105 is configured to regulate an exchange of active and reactive power between the arrangement 102 and the AC voltage grid 1, taking into account the measured and setpoint values.

FIG. 20 shows a section of the device 107 in FIG. 19 comprising the arrangement 102. FIG. 20 shows a power converter 9 that is a modular multilevel converter (MMC) in a double-star configuration. The power converter 9 comprises six power converter arms 10. Three of the power converter arms 10 are connected to one another in a first star connection with a first star point or DC voltage pole P. A further three of the power converter arms 10 are connected to one another in a second star point connection with a second star point or DC voltage pole N. Each of the power converter arms extend between one of three AC voltage connections L1-L3 and one of the two DC voltage poles P,N. The structure of the power converter arms 10 will be looked at in more detail in the following FIG. 21. The AC voltage connections L1-L3 form an AC voltage side 9ac of the power converter 9 for connection to the AC voltage grid 1. The DC voltage poles P,N form a DC voltage side 9dc of the power converter 9 for connection to an energy storage arrangement E. The energy storage arrangement E comprises one or more series circuits of energy storage modules EM that can be arranged in parallel with one another. The energy storage modules EM can have, for example, ultracapacitors or comparable short-term energy stores.

A controlled load 108 is arranged in series with the energy storage arrangement E, by means of which load additional active power can be taken up from the AC voltage grid 1 and possibly converted into heat. The series circuit of the energy storage arrangement E and the load 108 extends between the DC voltage poles P,N of the power converter 9. The structure of the load 108 will be looked at in more detail below in connection with FIGS. 22 to 24.

FIG. 21 shows an example of a power converter arm 10 for the power converter 9 in FIG. 20. The power converter arm 10 has two connections A1 and A2, by means of which the power converter arm can be connected between one of the AC voltage connections L1-3 and one of the DC voltage poles P or N. The power converter arm 10 comprises a series circuit of switching modules 13, the structure of which corresponds to that of the switching modules that are described in more detail in connection with FIGS. 4 to 6. The switching module voltages dropped across the switching modules 13 add up to form an arm voltage u_conv. The power converter arm also comprises a smoothing inductor 12. An arm current i_conv through the power converter arm 10 is detected by means of an ammeter 11 and is forwarded to the regulation apparatus 105 of the power converter.

FIG. 22 shows a controllable load 108a that can be used as the controlled load 108 in FIG. 20. The load 108a comprises a high-power resistor 121 that is connected in parallel with a switch 122, by means of which the high-power resistor 121 can be bypassed. By way of example, the load 108a can be connected between a potential point Q, at which the load is connected to the energy storage arrangement E, and the DC voltage pole N of the arrangement 102 in FIG. 20.

FIG. 23 shows a controlled load 108b that can be used as the controlled load 108 in FIG. 20. The load 108b comprises a high-power resistor 121 that is connected in parallel with a diode 109. The forward direction of the diode 109 is selected in such a way that the high-power resistor is not effective when energy is output into the grid. By way of example, the load 108b can be connected between a potential point Q, at which the load is connected to the energy storage arrangement E, and the DC voltage pole N of the arrangement 102 in FIG. 20.

FIG. 24 shows a braking controller 17 that can be used as the controlled load 108 in FIG. 20. The braking controller 17 comprises a coupling inductor 25 and a series circuit of a plurality of braking controller modules 24 that have an identical structure in the example shown. A current i_BC through the braking controller 17 is measured by means of an ammeter 26 and used to regulate the braking controller 17 by means of a regulator that is not shown in greater detail. The structure of the braking controller modules 24 will be looked at in detail in FIGS. 15 to 18.

The method of operation of the devices 7 and 107 of the preceding figures can be described on the basis of the flowchart in FIG. 25 as follows.

In a first step 201, a device according to the invention, e.g. the device 7 in FIG. 1 or the device 107 in FIG. 19, is provided and is connected to an AC voltage grid and put into operation, with the result that reactive and/or active power can be exchanged with the AC voltage grid by means of the device.

In a second step 202, active power is taken up from the AC voltage grid and is stored by means of the energy storage arrangement E (see FIGS. 1 and 19). During the take-up of power, the take-up of active power is delayed or slowed down by means of the controlled load 8 or 108 by a portion of the active power or energy being converted into heat.

As soon as a take-up capacity threshold of the energy storage arrangement has been reached (the energy storage modules EM or ultracapacitors or the like used here are fully charged and cannot take up any further power or energy), in a further step 203, further active power is drawn from the AC voltage grid, wherein this further active power is at least partially converted into heat by means of the controlled load.

1-13 (canceled).

14. A device for stabilizing an AC voltage grid, the device comprising:
a power converter with an AC voltage side for connection to the AC voltage grid and a DC voltage side with two DC voltage poles;
an energy storage arrangement connected between said DC voltage poles (P,N) on said DC voltage side of said power converter; and
a controlled load disposed in series or parallel with said energy storage arrangement for absorbing active power.

15. The device according to claim 14, wherein said controlled load includes at least one resistor element.

16. The device according to claim 15, wherein said controlled load is connected in series with said energy storage arrangement, and a diode is connected in parallel with said at least one resistor element.

17. The device according to claim 15, wherein said controlled load is connected in series with said energy storage arrangement, and a bypass switch is connected in parallel with said resistor element, said bypass switch configured to bypass said resistor element.

18. The device according to claim 14, wherein said controlled load includes a braking controller.

19. The device according to claim 18, wherein said braking controller has a series circuit of braking controller modules.

20. The device according to claim 14, wherein said controlled load forms a series circuit with a switching unit connected in parallel with said energy storage arrangement.

21. The device according to claim 14, wherein said controlled load includes a first load branch and a second load branch disposed in parallel with one another, said first load branch includes at least one controllable resistor element and said second load branch includes a further controllable resistor element or a braking controller.

22. The device according to claim 21, which further comprises a semiconductor switch or a mechanical switch connected in series with said resistor element for controlling said resistor element.

23. The device according to claim 14, wherein said energy storage arrangement has a plurality of parallel-connected series circuits including energy storage units.

24. The device according to claim 14, wherein said power converter is a modular multilevel power converter in a double-star configuration.

25. A method for operating a device for stabilizing an AC voltage grid, the method comprising:
providing the device according to claim 14;
taking-up active power from the AC voltage grid and using said energy storage arrangement to store the active power; and
using said controlled load to delay or slow down the take-up of active power.

26. The method according to claim 25, which further comprises upon the taken-up active power reaching a take-up capacity threshold of said energy storage arrangement, drawing further active power from the AC voltage grid and at least partially converting the further active power into heat by using said controlled load.
